(19) United States
(12) Patent Application Publication
(10) Pub. No.: US 2003/0076581 A1
(43) Pub. Date: Apr. 24, 2003

(54) Method and apparatus for monitoring of data channels

(76) Inventor: Simon Charles Fleming, New South Wales (AU)

Correspondence Address: LADAS & PARRY, 224 SOUTH MICHIGAN AVENUE, SUITE 1200, CHICAGO, IL, 60604, US

(21) Appl. No.: 10/181,298

(22) PCT Filed: Jan. 17, 2001
(86) PCT No.: PCT/AU01/00040

(30) Foreign Application Priority Data
Jan. 17, 2000 (AU) PQ 5117

(51) Int. Cl. H01S 3/00

(52) U.S. Cl. 359/344

(57) ABSTRACT

According to a first aspect of the present invention, there is provided a method for monitoring individual wavelength division multiplexed data channel signals of a multiple data channel optical signal which is being amplified by a gain-clamped optical amplifier, the method comprising the steps of modulating each wavelength division multiplexed data channel signal with an associated lower frequency identification signal before the optical signal is amplified, the frequency of each identification signal being chosen such that it uniquely identifies the associated data channel signal and such that at least a portion of each identification signal is transferred onto a gain-clamping signal of the amplifier, and monitoring each identification signal as a component of the gain-clamping signal. There is also provided a gain-clamped optical amplifier for amplifying a multiple data channel optical signal.

### FIELD OF THE INVENTION

The present invention relates broadly to a method for monitoring individual data channel signals of a multiple data channel optical signal which is being amplified by a gain-clamped optical amplifier, and to a gain-clamped optical amplifier for amplifying a multi data channel optical signal.

### BACKGROUND OF THE INVENTION

Multiple data channel optical signals are for example used in wavelength division multiplexing (WDM) systems. Such optical signals consist of multiple wavelength channels, each of which is modulated with a high frequency data signal. These wavelength- or data-channels are typically closely spaced in terms of their wavelength separation. Such optical signals are frequently amplified in the WDM systems using for example erbium-doped fibre amplifiers (EDFA). EDFA's are optical amplifiers in which the amplification is due to transitions from meta-stable levels to ground levels of excited erbium ions.

Such optical amplifiers will follow low frequency fluctuations and thus, the gain at a particular wavelength may vary due to fluctuations in other data channels of the multiple data channel signal. Gain-clamped optical amplifiers, e.g. gain-clamped EDFAs, seek to reduce the effects of low frequency changes, such as channels dropping out of the multiple data channel signal. This is achieved by simultaneously lasing, or other feedback techniques. The laser output (or other feedback signal) adjusts to absorb the low frequency variation.

In WDM systems it is desirable to be able to monitor the presence/level of the individual data channels. One way of achieving this is to de-multiplex the optical signal at different locations of the WDM system, which is herein referred to as an active monitoring technique. However, it will be appreciated that such active monitoring involves complex and expensive de-multiplexing equipment, and thus it does not represent an efficient way of monitoring the WDM system.

It is therefore desirable to provide a method and apparatus suitable for passive monitoring of individual channels in WDM systems, ie. monitoring that does not involve de-multiplexing the WDM signal.

### SUMMARY OF THE INVENTION

According to a first aspect of the present invention, there is provided a method for monitoring individual wavelength division multiplexed data channel signals of a multiple data channel optical signal which is being amplified by a gain-clamped optical amplifier, the method comprising the steps of modulating each wavelength division multiplexed data channel signal with an associated lower frequency identification signal before the optical signal is amplified, the frequency of each identification signal being chosen such that it uniquely identifies the associated data channel signal and such that at least a portion of each identification signal is transferred onto a gain-clamping signal of the amplifier, and monitoring each identification signal as a component of the gain-clamping signal.

The gain-clamping signal may comprise a laser signal for co-lasing the optical amplifier.

The gain-clamping signal may alternatively comprise an electronic feedback signal provided to a pump of the optical amplifier.

The step of modulating each data channel signal may be conducted as part of generating each data channel signal for the optical signal.

Alternatively, the step of modulating each data channel signal may be conducted on the optical signal.

Where the step of modulating each data channel signal is conducted on the optical signal, the step of modulating may comprise varying the reflectivity of an associated low reflection grating located in an optical waveguide in which the optical signal propagates, the grating being configured for the wavelength of the associated data channel signal.

The step of monitoring each identification signal may comprise measuring an intensity signal of the gain-clamping signal. The step of monitoring each identification signal may further comprise Fourier transforming the intensity signal.

The amplifier may comprise a rare-earth-doped fibre amplifier, such as an erbium-doped fibre amplifier.

The frequency of each identification signal may be chosen such that transfer of the identification signal onto an output signal of the amplifier is substantially avoided.

Alternatively, the frequency of each identification signal may be chosen such that a portion of the identification signal is transferred onto the output signal. This can enable carrying through of the identification signals to a further optical amplifier for further monitoring the channel signals.

By suitable choice of sufficiently low frequency monitoring signals the system can be configured such that essentially all the monitoring signal is removed to the gain-clamping means and thus there is essentially no detrimental effect on the data signal. Alternatively frequencies may be chosen whereby some desired fraction appears on the data output for further monitoring downstream.

According to a second aspect of the present invention, there is provided a gain-clamped optical amplifier for amplifying a multiple data channel optical signal, the amplifier comprising means for monitoring lower frequency identification signals on individual data channel signals of the optical signal as components of a gain-clamping signal of the amplifier.

According to a third aspect of the present invention, there is provided a gain-clamped optical amplifier for amplifying a multiple-data-channel optical signal, the amplifier comprising: a signal generating means arranged to apply a unique, relatively low frequency, identification signal onto each data channel of the optical signal; an optical amplifier arranged to amplify each data channel of the optical signal; a monitoring means arranged to monitor the amplified intensity of the identification signal on each data channel at an output of the amplifying means; and a gain-clamping means arranged to control the optical amplifier to maintain constant gain of each data channel, based on the monitored intensity of the identification signal.

The gain-clamping means may comprise a laser source arranged to co-lase the optical amplifier. Alternatively, the gain-clamping means may comprise an electronic feedback signal arranged to control an optical pump of the optical amplifier.

The optical amplifier may comprise a rare-earth-doped fibre amplifier, such as an erbium-doped fibre amplifier.

The signal generating means may comprise: a grating disposed in the waveguide in which the optical signal propagates, the grating being tuned to the wavelength of a particular data channel in the optical signal; and a modulating means arranged to modulate optical reflectivity of the grating.

The modulating means may comprise an electro-acoustic modulator.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 is a schematic representation of the preferred embodiment; and

FIGS. 2 to 4 illustrate examples of the monitoring process.

### DESCRIPTION OF PREFERRED AND OTHER EMBODIMENTS

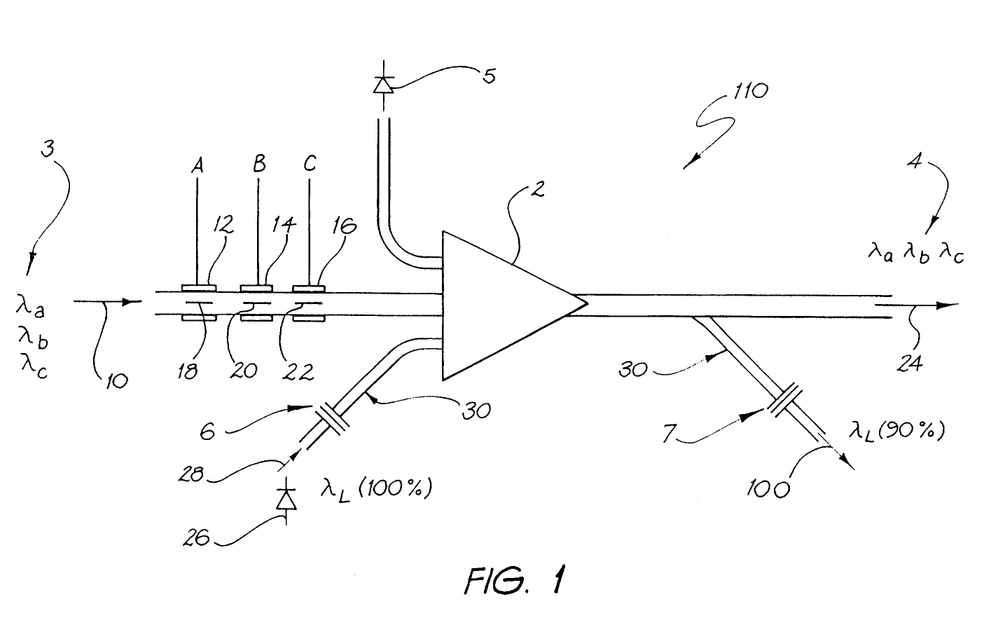

In FIG. 1, there is illustrated a schematic of the preferred embodiment wherein an erbium-doped fibre amplifier (EDFA) 2 is provided for amplifying input channels 3 to produce amplified output channels 4 of the output signal 24. The erbium-doped fibre amplifier 2 is pumped by a pump source 5.

The input channels λa, λb, λc of a high frequency multi channel optical signal 10 are modulated by low frequency identification signals in the form of pilot tones A, B, C. The modulation is achieved on the optical signal 10 utilising electro-acoustic modulators 12, 14, 16 (such as a piezo-electric modulators) surrounding associated very low reflection (1%) gratings 18, 20, 22 tuned to the wavelength λa, λb and λc respectively.

The gain dynamics of the EDFA 2 are slow and cross-talk rolls off at relatively low frequencies. Usually this is determined principally by the inverse half-life of the meta-stable level of the EDFA 2 (about 100 Hz) but it can be influenced by the pump and signal modes.

In the EDFA 2 of this embodiment, gain-clamping is achieved by co-lasing using a further source 26. The co-lasing signal path 30 includes two reflection gratings 6, 7, with the grating 6 being fully reflective and the grating 7 being less than 10% reflective for a propagation direction away from the EDFA 2.

The gain-clamping works by the co-lasing source 26 adjusting its output power to compensate for fluctuations in the input power to the EDFA 2 in the optical signal 10 such as channel dropping, which would otherwise cause fluctuation in the gain experienced by the other channels. Thus, a regulated amplification is achieved for signals representing data on each of the channels 3.

To illustrate the gain-clamping further, when the power on a particular one of the input channels 3 decreases, the other channels would experience a larger gain without gain-clamping. Similarly, when the input power on a particular one of the channels 3 increases, the other channels would experience a smaller gain without gain-clamping. Accordingly, by automatically varying the power of the co-lasing signal 28 to compensate for such fluctuations, the equilibrium of gain and losses within the EDFA is maintained without changes to the gain experienced by the individual channels 3.

Low frequency pilot tones of say 10 Hz will (almost) disappear from the data channel during the amplification by the EDFA 2, but will appear on the output 100 of the co-lasing path 30.

Therefore, in the preferred embodiment each one of the input channels 3 is modulated with a low frequency pilot tone, i.e. A, B, C. Non-integer relationships between the tones A, B, C are desirable as it makes it easier to uniquely identify the respective signals in the output signal 100 by means of a Fourier analysis.

Filtering or Fourier analysis on the co-lasing output signal 100 provides information on the presence and magnitude of each of the channels 3. As the pilot tones A, B, C are very low frequencies this becomes an essentially trivial exercise. It is thus possible to draw conclusions as to the activity on the various channels 3.

Accordingly, a low-cost means of monitoring channel integrity in a WDM system can be achieved which can be easily integrated with other supervisory systems.

The operation of the above-described system 110 will now be further described.

In the example shown in FIG. 2, all channels are operating properly (see plot 200), and a Fourier analysis (see plot 210) of the co-lasing output signal shows approximately the same magnitude for each of the pilot tone signals A, B, C.

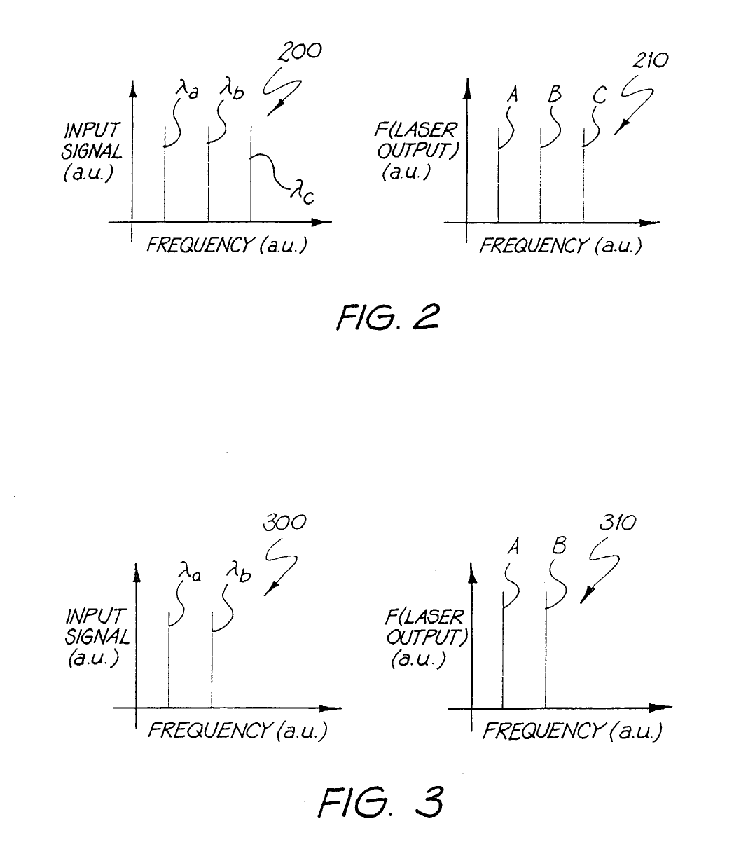

As illustrated in FIG. 3, the absence of one of the channels, λC (plot 300) results in pilot tone signal C disappearing from the Fourier analysis (plot 310). It is noted here that the magnitudes of the remaining pilot tone signals A, B in the co-lasing output signal are increased, whilst the magnitudes of channels λa and λb remain constant, illustrating the gain-clamping effects described above.

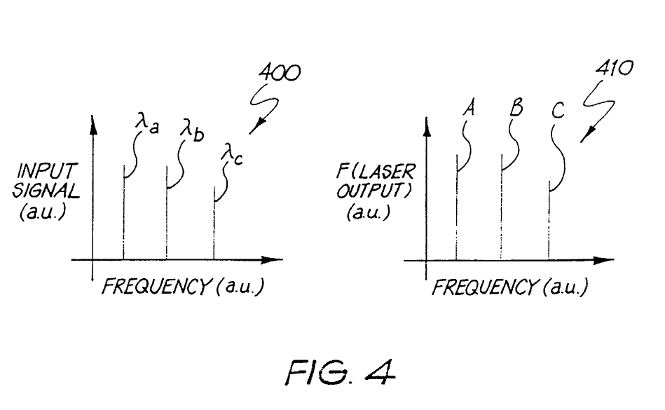

As illustrated in plot 400 of FIG. 4, degradation of one of the channels λC is indicated in the Fourier analysis (plot 410) by a relative decrease in the magnitude of pilot tone signal C. Again it is noted here that the magnitudes of the remaining pilot tone signals A, B in the co-lasing output signal are increased, whilst the relative magnitudes of channels λa, λb and λc remain constant, further illustrating the gain-clamping effects described above.

The technique is most easily suited to systems which include only a single amplifier. However, the technique can be modified for use in WDM systems that include a number of consecutive amplifiers.

There are different ways of achieving this. In one embodiment, the pilot tones are chosen with frequencies which are not entirely filtered out by the EDFA. A portion of the pilot tone signals will thus pass through onto the output signal of the EDFA, whilst the remainder of the pilot tone signals will be transferred onto the co-lasing signal. It is noted that whilst still providing a passive technique, it would require a complex analysis as the ratio of transfer to pass through of the EDFA may vary with wavelength and frequency.

Alternatively, in another embodiment, pilot tones are repeatedly modulated onto the individual data channels between the output of one of the amplifiers and the input of the next amplifier. In such an embodiment, the frequencies of the pilot tones would be chosen such that they are substantially entirely filtered out by the individual amplifiers.

It would be appreciated by a person skilled in the art that numerous variations and/or modifications may be made to the present invention as shown in the specific embodiment without departing from the spirit or scope of the invention as broadly described. The present embodiment is, therefore, to be considered in all respects to be illustrative and not restrictive.

The claims defining the invention are as follows:

1. A method for monitoring individual wavelength division multiplexed data channel signals of a multiple data channel optical signal which is being amplified by a gain-clamped optical amplifier, the method comprising the steps of:
modulating each wavelength division multiplexed data channel signal with an associated lower frequency identification signal before the optical signal is amplified, the frequency of each identification signal being chosen such that it uniquely identifies the associated data channel signal and such that at least a portion of each identification signal is transferred onto a gain-clamping signal of the amplifier, and
monitoring each identification signal as a component of the gain-clamping signal.

2. A method as claimed in claim 1, wherein the gain-clamping signal comprises a laser signal for co-lasing the optical amplifier.

3. A method as claimed in claim 1, wherein the gain-clamping signal comprises an electronic feedback signal provided to a pump of the optical amplifier.

4. A method as claimed in any one of claims 1 to 3, wherein the step of modulating each data channel signal is conducted as part of generating each data channel signal for the optical signal.

5. A method as claimed in any one of claims 1 to 3, wherein the step of modulating each data channel signal is conducted on the optical signal.

6. A method as claimed in claim 5, wherein the step of modulating comprises varying the reflectivity of an associated low reflection grating located in an optical waveguide in which the optical signal propagates, the grating being configured for the wavelength of the associated data channel signal.

7. A method as claimed in any one of the preceding claims, wherein the step of monitoring each identification signal comprises measuring an intensity signal of the gain-clamping signal.

8. A method as claimed in claim 7, wherein the step of monitoring each identification signal may further comprise Fourier transforming the intensity signal.

9. A method as claimed in any one of the preceding claims, wherein the amplifier comprises an erbium-doped fibre amplifier.

10. A method as claimed in any one of the preceding claims, wherein the frequency of each identification signal is chosen such that transfer of the identification signal onto an output signal of the amplifier is substantially avoided.

11. A method as claimed in any one of claims 1 to 9, wherein the frequency of each identification signal is chosen such that a portion of the identification signal is transferred onto the output signal.

12. A gain-clamped optical amplifier for amplifying a multiple data channel optical signal, the amplifier comprising:
means for monitoring lower frequency identification signals on individual data channel signals of the optical signal as components of a gain-clamping signal of the amplifier.

13. A gain-clamped optical amplifier for amplifying a multiple-data-channel optical signal, the amplifier comprising:
a signal generating means arranged to apply a unique, relatively low frequency, identification signal onto each data channel of the optical signal;
an optical amplifier arranged to amplify each data channel of the optical signal;
a monitoring means arranged to monitor the amplified intensity of the identification signal on each data channel at an output of the amplifying means; and
a gain-clamping means arranged to control the optical amplifier to maintain constant gain of each data channel, based on the monitored intensity of the identification signal.

14. The gain-clamped optical amplifier according to claim 13, wherein the gain-clamping means comprises a laser source arranged to co-lase the optical amplifier.

15. The gain-clamped optical amplifier according to claim 13, wherein the gain-clamping means comprises an electronic feedback signal arranged to control an optical pump of the optical amplifier.

16. The gain-clamped optical amplifier according to any one of claims 13-15, wherein the optical amplifier comprises an erbium-doped fibre amplifier.

17. The gain-clamped optical amplifier according to any one of claims 13-16, wherein the signal generating means comprises:
a grating disposed in the waveguide in which the optical signal propagates, the grating being tuned to the wavelength of a particular data channel in the optical signal; and
a modulating means arranged to modulate optical reflectivity of the grating.

18. The gain-clamped optical amplifier according to claim 17, wherein the modulating means comprises an electro-acoustic modulator.
